(19) United States
(12) Patent Application Publication
(10) Pub. No.: US 2018/0150906 A1
(43) Pub. Date: May 31, 2018

(54) SYSTEM AND METHOD FOR ENABLING AN INVESTOR OR A BUYER TO PURCHASE A REAL ESTATE PROPERTY WITH POTENTIAL EQUITY

(71) Applicant: Yaser Aldineh, Dayton, OH (US)

(72) Inventor: Yaser Aldineh, Dayton, OH (US)

(21) Appl. No.: 15/361,464

(22) Filed: Nov. 27, 2016

(51) Int. Cl. G06Q 30/08; G06Q 40/06

(52) U.S. Cl. CPC G06Q 30/08; G06Q 50/16; G06Q 40/06

(57) ABSTRACT

A system and computer implemented method of enabling an investor or buyer to purchase a real estate property with potential equity. The system comprising a memory unit to store a database comprising information regarding a plurality of real estate properties posted for sale by a realtor and a set of program modules. The system comprises a processor to execute the set of program modules. The set of program modules comprises an input module, a display module, a real estate selection module, a purchasing module and a compatibility module. The purchasing module is configured to receive from the investor or buyer, a request to purchase at least one real estate property among the set of real estate properties, and to receive at least one monetary transaction from the investor or buyer to purchase at least one real estate property, thereby enabling the investor or buyer to purchase at least one real estate property with the help of their realtor.

### BACKGROUND OF THE INVENTION

### A. Technical Field

The present invention generally relates to the technical field of real estate brokerage websites, and more specifically relates to a system and method for enabling an investor or a buyer to purchase a real estate property with potential equity.

### B. Description of Related Art

websites have pervaded every aspect of life in the twenty first century. Examples of websites include, but are not limited to AMAZON, CRAIGLIST, and EBAY. Today, user access to websites are used for multiple purposes. As often is the case, realtors access websites looking for real estate investments.

In one example, a website may sell real estate to investors and buyers. However, the website has several serious drawbacks. For example, the website fails to involve realtors and streamline the purchase process. Moreover, the website fails to provide realtors, investors and buyers with automatic notifications. Furthermore, the website fails to generate and provide nearby statistics and reports about available real estate. Furthermore, the website fails to enable realtors and real estate industry vendors to purchase marketing material and advertising. Moreover, the website fails to have a feature for locating contractors, real estate vendors and requesting bids or services from the contractors and vendors. Furthermore, the website fails to contact potential clients, and send marketing emails. Moreover, the website fails to create a project workspace (spreadsheet, etc.) and fails to support multiple languages.

Therefore, there is a need in the art for a secure website and management platform having a feature of enabling an investor or a buyer to purchase a real estate property with potential equity.

### SUMMARY OF THE INVENTION

The present invention relates to a system and method for enabling an investor or a buyer to purchase a real estate property with potential equity.

In one embodiment of the present invention, a system for enabling an investor or a buyer to purchase a real estate property with potential equity. The system comprising a memory unit to store a database comprising information regarding a plurality of real estate properties posted for sale by a realtor and a set of program modules. The system comprises a processor to execute the set of program modules. The set of program modules comprises an input module, a display module, a real estate selection module, a purchasing module, and a compatibility module. The input module, executed by the processor, is configured to receive from the investor or buyer, preferences of the investor or buyer about purchasing a real estate property with potential equity. The compatibility module is configured to calculate compatibility of each of the plurality of real estate properties with the preferences of the investors and the buyers. The real estate property selection module is configured to select a set of real estate properties from the plurality of real estate properties based upon the preferences of the investor or buyer being compatible with the set of real estate properties. The display module is configured to present the investor or buyer with the set of real estate properties. The purchasing module is configured to receive from the investor or buyer, a request to purchase at least one real estate property among the set of real estate properties, and to receive at least one monetary transaction from the investor or buyer to purchase at least one real estate property, thereby enabling the investor or buyer to purchase at least one real estate property with the help of their assigned realtor.

In one embodiment of the present invention, a computer-implemented method of enabling an investor or a buyer to purchase a real estate property comprises storing in a memory unit information regarding a plurality of real estate properties posted for sale by a realtor. Further, the method comprises receiving, at a processor via an input module, preferences of an investor or a buyer about purchasing a real estate property. Further, the method comprises calculating, by the processor via a compatibility module, compatibility of each of the plurality of real estate properties with the preferences of the investor or the buyer. Further, the method comprises selecting, by the processor, via a real estate selection module, a set of real estate properties from the plurality of real estate properties based upon the preferences of the investor or buyer being compatible with each of the set of real estate properties. Further, the method comprises presenting, by the processor via a display module, the set of real estate properties to the investor or buyer. Further, the method comprises receiving by the processor via a purchasing module, a request from the investor or buyer, to purchase at least one real estate property among the set of real estate properties. Further, the method comprises receiving by the processor via the purchasing module, at least one monetary transaction from the investor or buyer to purchase at least one real estate property, thereby enabling the investor or buyer to purchase at least one real estate property with the help of their assigned realtor. In an embodiment of the present invention, information regarding the plurality of real estate properties comprises, location of the plurality of real estate properties, flood zone maps of areas near the plurality of real estate properties, proximity of the plurality of real estate properties to schools, commercial districts, hospitals, and government offices, in area surrounding the plurality of real estate properties including property investment, purchase price, potential equity, potential return on investment, individual property characteristics and amenities available in the plurality of real estate properties. In one embodiment of the present invention, the preferences of the investor or buyer comprise the location of the real estate property, flood zone maps of areas near the real estate property, proximity of the real estate properties to schools, commercial districts, hospitals, and government offices in area surrounding at least one real estate properties, and amenities offered by the real estate property. In another embodiment of the present invention, the compatibility module is further configured to notify the investor or buyer about the set of real estate properties via at least one of an email, a text message, a voicemail and a phone call. In yet another embodiment of the present invention, the purchasing module is further configured to enable the investor or buyer to review at least one real estate property and post comments in a social media forum about at least one real estate property. In yet another embodiment of the present invention, the display module is further configured to present advertisements about the plurality of real estate properties and request bids from one or more potential investors or buyers. In yet another embodiment of the present invention, the display module is configured to present the investor or buyer with information regarding the plurality of real estate properties via at least one of charts, graphs, tables, and pie charts.

### BRIEF DESCRIPTION OF DRAWINGS

FIG. 1 is a block diagram of an environment implemented in accordance with various embodiments of the invention.

FIG. 2 is a block diagram of realtor mobile application component in accordance with various embodiments of the invention.

FIG. 3 is flow chart of a computer-implemented method of enabling an investor or a buyer to purchase a real estate property, according to an embodiment of the present invention.

FIG. 4 is a screenshot view of a realtors report screen according to an embodiment of the present invention.

FIG. 5 is a screenshot view of a real estate property mapping according to an embodiment of the present invention.

FIG. 6 is a screenshot view of a real estate property list screen according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

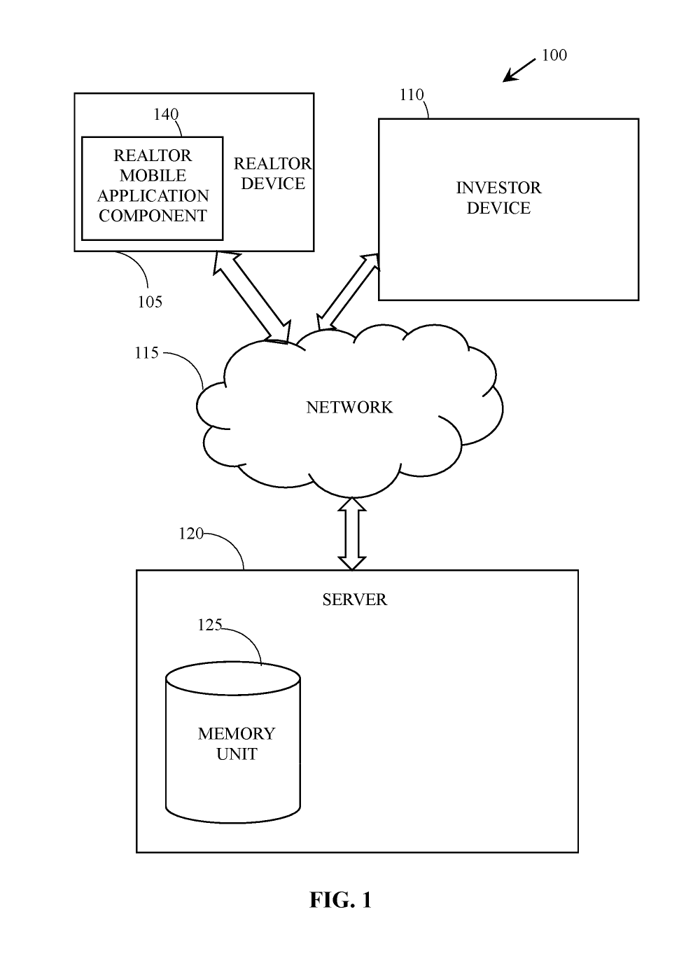

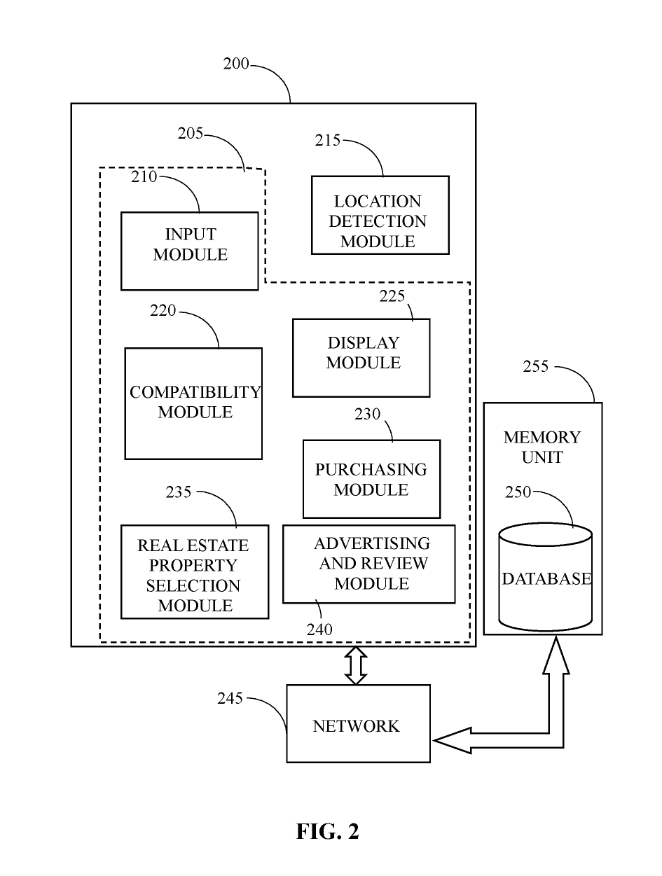

FIG. 1 is a block diagram of an environment 100 in accordance with which various embodiments of the present invention are implemented. The environment 100 comprises a realtor device 105, an investor or a buyer device 110, a network 115, and a server 120. The realtor device 105 and the investor or buyer device 110 are at least one of tablet computers, personal computers, smart phones, smart televisions and laptops. In one embodiment of the present invention, the realtor device 105 and the investor or buyer device 110 comprises a Global Positioning System (not shown). In one example, the realtor device 105 enables a realtor to communicate with the server 120 via the network 115. The server 120 comprises a memory unit 125. The realtor device 105 comprises a realtor mobile application component 140. A block diagram of an exemplary implementation of the realtor mobile application component 140 is illustrated in FIG. 2.

Referring to FIG. 2, a realtor mobile application component 200 comprises a processor 205 and a location detection module 215. The realtor mobile application component 200 communicates with a memory unit 255 in a server (not shown) via a network 245. The network 245 is at least one of a mobile network, a wide area network and a wireless radio network. The memory unit comprises a set of program modules comprising an input module 210, a compatibility module 220, a display module 225, a purchasing module 230, a real estate property selection module 235, and an advertising and review module 240.

Further, the memory unit 255 comprises a database 250 comprising one or more records. The records comprise a first list of services offered by at least one realtor, pictures of the realtor, name and contact information of the realtor, and information regarding a plurality of real estate properties posted for sale by the realtor. The first list of services includes, but is not limited to a marketing service, a brokerage service, an advertising service and a rental service. The memory unit 255 transmits the records to the realtor mobile application component 200.

As mentioned earlier, the realtor mobile application component 200 comprises the processor 205 and the location detection module 215. The location detection module 215 is implemented in an Application Specific Integrated Circuit Chip. The location detection module 215 comprises a Global Positioning System (GPS) device. The location detection module 215 receives information regarding location of the realtor mobile application component 200 from the GPS device. Further, the location detection module 215 communicates with the GPS device (not shown). Further, the location detection module 215 receives one or more data items from the GPS module and determines a location of the realtor based upon the one or more data items. The one or more data items comprise information regarding coordinates of the realtor in accordance with one of a radial, linear and cartographical system. The location detection module 215 transmits information regarding location of the realtor mobile application component 200 into the processor 205.

The processor 205 receives the records from the memory unit 255. As mentioned earlier, records comprise a first list of services offered by the realtor, pictures of the realtor, name and contact information of the realtor, and information regarding a plurality of real estate properties posted for sale by the realtor. Information regarding the plurality of real estate properties comprises, location of the plurality of real estate properties, proximity of the plurality of real estate properties to schools, commercial districts, hospitals, and government offices in area surrounding the plurality of real estate properties, flood zone maps of areas near the plurality of real estate properties, including property investment, purchase price, potential equity, potential return on investment, individual property characteristics and amenities available in the plurality of real estate properties. Further the processor 205 receives the set of program modules. As mentioned earlier, the set of program modules comprises the input module 210, the compatibility module 220, the display module 225, a purchasing module 230, the real estate property selection module 235, and the advertising and review module 240. The processor 205 executes the set of program modules.

The input module 210, executed by the processor, is configured to receive from an investor or a buyer, preferences of the investor or buyer about purchasing a real estate property. Examples of the real estate property include, but is not limited to a house, a condominium, a building, a plot of land and a hotel. Examples of the preferences include but is not limited to the preferences of the investor or buyer comprise location of the real estate property, flood zone maps of areas near the real estate property, proximity of the real estate properties to schools, commercial districts, hospitals, and government offices in area surrounding at least one real estate properties, including property investment, purchase price, potential equity, potential return on investment, individual property characteristics and amenities offered by the real estate property. The input module 210 receives the preferences from an investor or a buyer device as shown in FIG. 1. The investor or buyer device receives the preferences from the investor or buyer via an input device (not shown). Examples of the input device includes but is not limited to a microphone, a keyboard, and a camera. The input module 210 transmits the preferences of the investor or buyer to the compatibility module 220.

The compatibility module 220 is configured to calculate compatibility of each of the plurality of real estate properties with the preferences of the investors or the buyer. Further, the compatibility module 220 is further configured to notify the investor or buyer about the set of real estate properties via at least one of an email, a text message, a voicemail, and a phone call. In one example, the compatibility module 220 calculates compatibility by comparing information regarding the plurality of real estate properties, in the memory unit 255, with the preferences of the investor or buyer. If the preferences are identical to the information about the first real estate property among the plurality of real estate properties, the compatibility module 220 identifies the first real estate property to be compatible with the preferences. The compatibility module 220 generates compatibility information for each of the plurality of real estate properties and transmits the compatibility information to the real estate property selection module 235. The real estate property selection module 235, selects a set of real estate properties from the plurality of real estate properties based upon the preferences of the investor or buyer being compatible with each of the set of real estate properties. Further, the real estate property selection module 235 transmits the set of real estate properties to the display module 225 and the purchasing module 230.

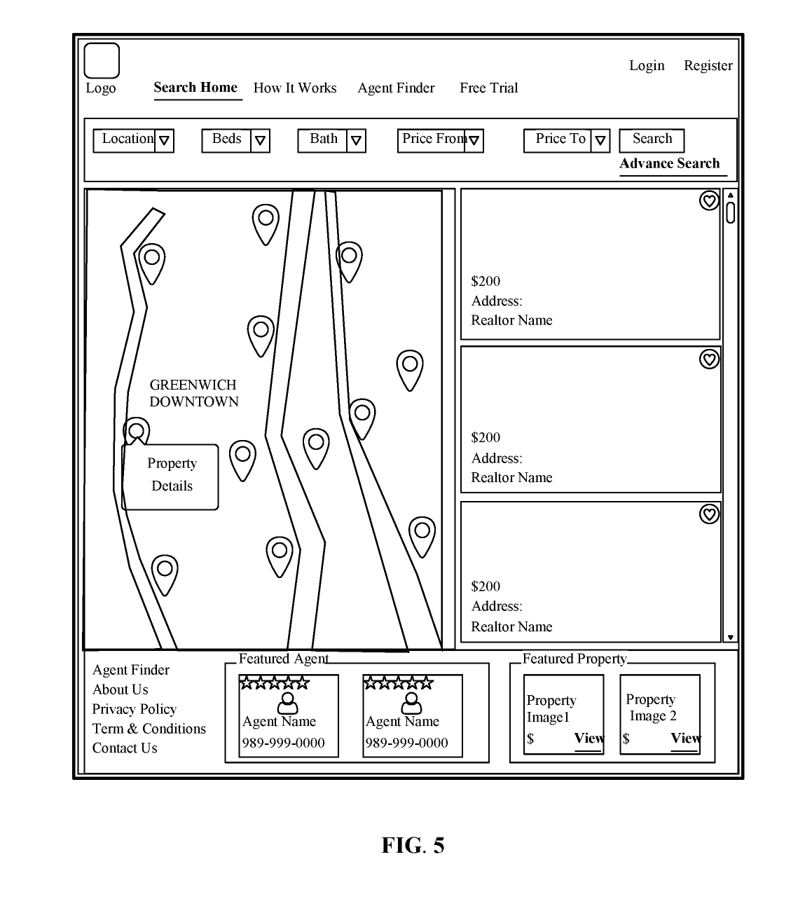

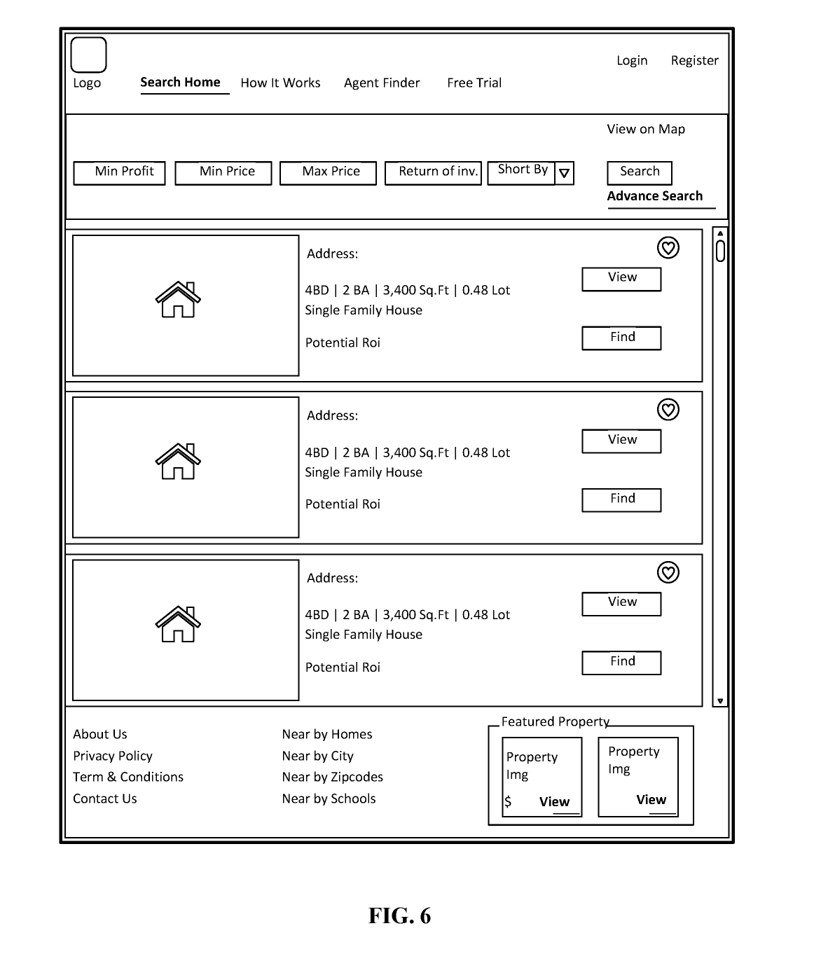

The display module 225 is configured to present the investor or buyer with the set of real estate properties. The display module 225 presents the set of real estate properties to the investor or buyer via an audio speaker, a computer screen, a smart television, and a smart phone. In one example, the display module 225 presents the set of real estate properties as locations on a map depicted on a computer screen. A first screenshot of the computer screen, when the display module 225 presents the set of real estate properties on the map, is exemplarily illustrated in FIG. 5. In another example, the display module 225 presents the set of real estate properties as a list on a web page. A second screenshot of the webpage, wherein the display module 225 presents the set of real estate properties as the list, is exemplarily illustrated in FIG. 6. The purchasing module 230, is configured to receive from the investor or buyer, a request to purchase at least one real estate property among the set of real estate properties. The purchasing module 230, receives the request from the investor or buyer via the input device in the investor device. Further, the purchasing module 230 receives at least one monetary transaction from the investor or buyer to purchase at least one real estate property, thereby enabling the investor or buyer to purchase at least one real estate property with the help of their realtor.

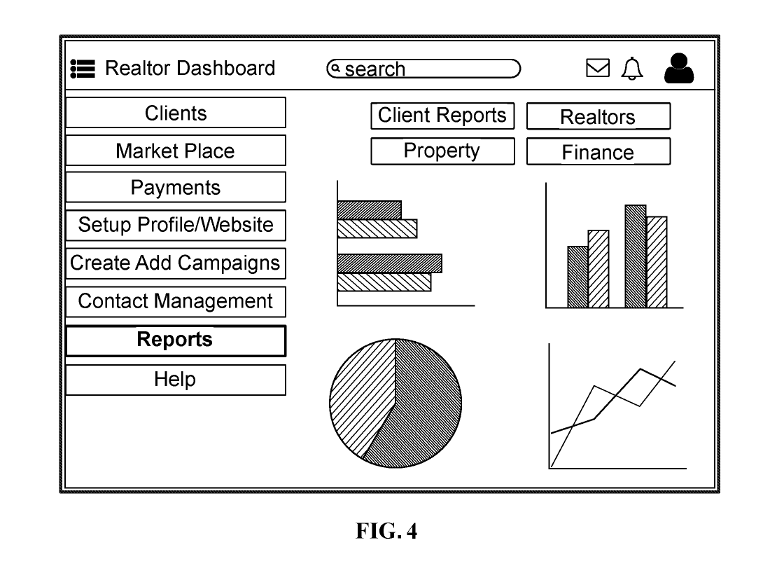

In one embodiment, the purchasing module 230 enables the investor or buyer to review at least one real estate property and to post comments in a social media forum about at least one real estate property, via the advertising and review module 240. In yet another embodiment of the present invention, the display module 225 causes the advertising and review module 240 to present advertisements about the plurality of real estate properties, to the investor or buyer, and request bids from one or more potential investors or buyers. In yet another embodiment of the present invention, the display module 225 is configured to present the investor or buyer with information regarding the plurality of real estate properties via at least one of charts, graphs, tables, and pie charts. In one example, the information regarding the plurality of real estate properties is presented to the investor or buyer on a first web page. An exemplary illustration of the first web page is shown in FIG. 4.

In one example, the real estate property selection module 235 generates spreadsheets with an estimated sale price of the set of real estate properties. Further, the real estate property selection module 235 receives a set of attributes from the investors or the buyers with regards to a desired type of real estate properties. The real estate property selection module 235 filters the set of real estate properties based on the set of attributes.

Further, the real estate property selection module 235 enables the realtor to recommend one or more contractors for the investor or the buyer. Further, the display module 225 generates a personalized website for each realtor. In one example, the personalized website is a sub-website for the realtors, and the sub-website shows only information pertaining to the realtor and no other realtor. Further, the sub-website shows all the properties regardless if the realtor is a listing realtor. In one example, the realtor is one of a listing realtor and a buyer's realtor. Further, the display module 225 presents the realtor with training videos. Further, the display module 225 presents the realtor with Google analytic data. Moreover, the real estate property selection module 235 enables the realtor, investor or the buyer to integrate social media platforms into the system. Examples of social media platforms include FACEBOOK, TWITTER and INSTAGRAM. Further, the purchasing module 230 generates invoices for the realtors and brokers to pay monthly dues. In one exemplary illustration of the present invention, each investor or buyer works with one realtor, assigned to the investor or buyer during one of a round robin, wherein the sign up in the personalized website is generated by the display module 225 for the realtor. Each visitor to the main website will see a list of realtors who subscribe or advertise in the main website. The list of realtors are stored in and loaded from the memory unit 255 by the display module 225. Further, a listing of real estate properties are be loaded by the realtor to the main website. In one example, the main website is HomeGrab.com. Further, the investor or buyer are buying the real estate property with the help of their realtor. The realtor is a representative to the buyer.

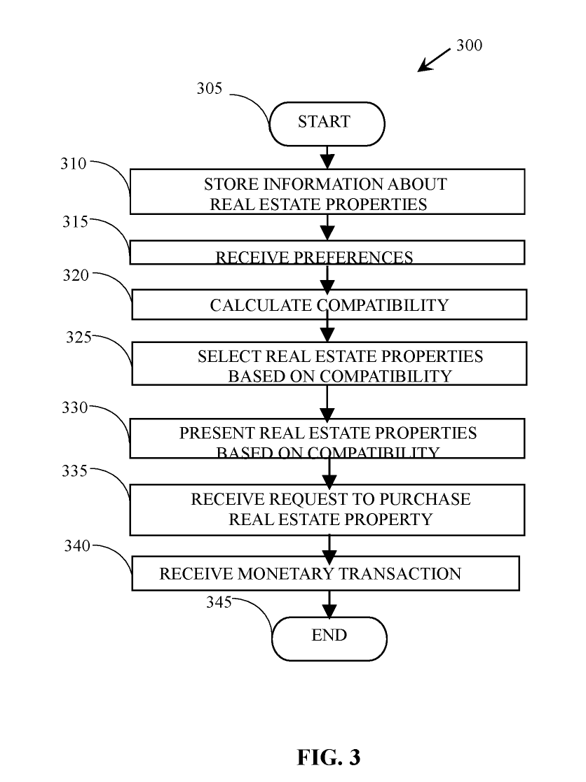

FIG. 3 is flow chart illustrating a computer-implemented method 300 of enabling an investor or a buyer to purchase a real estate property, according to yet another embodiment of the present invention. The method 300 is implemented in a computer system comprising a memory unit and a processor. The memory unit comprises a set of program modules comprising an input module, a compatibility module, a display module, a purchasing module, a real estate property selection module, an advertising and review module.

Further, the memory unit comprises a database comprising one or more records. The records comprise a first list of services offered by at least one realtor, pictures of the realtor, and name and contact information of the realtor. The first list of services includes, but is not limited to a marketing service, a brokerage service, an advertising service and a rental service. As mentioned earlier, the realtor mobile application component comprises the processor and the location detection module. The location detection module is implemented in an Application Specific Integrated Circuit Chip. The location detection module comprises a Global Positioning System (GPS) device. The location detection module receives information regarding location of the realtor mobile application component from the GPS device. Further, the location detection module communicates with the GPS device (not shown). Further, the location detection module receives one or more data items from the GPS module and determines a location of the realtor based upon the one or more data items. The one or more data items comprise information regarding coordinates of the realtor in accordance with one of a radial, linear and cartographical system. The location detection module transmits information regarding location of the realtor mobile application component into the processor. The method 300 commences at step 305.

At step 310, the memory unit stores information regarding a plurality of real estate properties posted for sale by the realtor. Information regarding the plurality of real estate properties comprises, location of the plurality of real estate properties, proximity of the plurality of real estate properties to schools, commercial districts, hospitals, and government offices in areas surrounding the plurality of real estate properties, flood zone maps of areas near the plurality of real estate properties, including property investment, purchase price, potential equity, potential return on investment, individual property characteristics and amenities available in the plurality of real estate properties. Further, the memory unit stores a set of program modules. The set of program modules comprises an input module, a compatibility module, a display module, a purchasing module, the real estate property selection module, the advertising and review module.

At step 315, the input module, executed by the processor, receives from the investor or the home buyer, individual preferences of the investor or the home buyer about purchasing a real estate property. Examples of the real estate property include, but are not limited to a house, a condominium, a building, a plot of land and a hotel. The input module receives the preferences from the investor device. The investor or the home buyer device receives the preferences from the investor or the home buyer via an input device. Examples of the input device includes but is not limited to a microphone, a keyboard, and a camera. The preferences of the investor comprise location of the real estate property, flood zone maps of areas near the real estate property, proximity of the real estate property to schools, commercial districts, hospitals, and government offices in area surrounding the real estate properties, including property investment, purchase price, potential equity, potential return on investment, individual property characteristics and amenities offered by the at least property. The input module transmits the preferences of the investor or the buyer to the compatibility module.

At step 320, the compatibility module calculates compatibility of each of the plurality of real estate properties with the preferences of the investors or the buyer. Further, the compatibility module notifies the investor or the buyer of the set of real estate properties via at least one of an email, a text message, a voicemail, and a phone call. In one example, the compatibility module calculates compatibility by comparing information regarding the plurality of real estate properties, in the memory unit, with the preferences of the investor. If the preferences are identical to the information about the first real estate property among the plurality of real estate property, the compatibility module identifies the first real estate property to be compatible with the preferences. The compatibility module generates compatibility information for each of the plurality of real estate properties and transmits the compatibility information to the real estate property selection module.

At step 325, the real estate property selection module, selects a set of real estate properties from the plurality of real estate properties based upon the preferences of the investor or the buyer being compatible with each of the set of real estate properties. Further, the real estate property selection module transmits the set of real estate properties to the display module and the purchasing module.

At step 330 the display module, presents the investor or the buyer with the set of real estate properties. The display module presents the set of real estate properties to the investor or the buyer via an audio speaker, a computer screen, a smart television and a smart phone. In one example, the display module presents the set of real estate properties as locations on a map depicted on a computer screen. In another example, the display module presents the set of real estate properties as a list on a web page.

At step 335, the purchasing module, receives from the investor or the buyer, a request to purchase at least one real estate property among the set of real estate properties. The purchasing module, receives the request from the investor or the buyer via the input device in the investor or the buyer device.

At step 340, the purchasing module receives at least one monetary transaction from the investor or the buyer to purchase at least one real estate property, thereby enabling the investor or the buyer to purchase at least one real estate property with the help of their realtor.

The method 300 ends at step 345.

Advantageously, the present invention enables the investors and buyers to easily locate real estate properties with containing equity and potentially make profit. Further, the present invention creates a work sheet for each real estate property and study profitability of purchasing the real estate property. Further, the present invention enables the investors and buyers to contact the realtors to schedule a showing or initiate a purchase process. The present invention enables the investor, buyer and the realtor to contact contractors and also book services provided from real estate vendors to home re-modelers. The present invention enables advertisements to the investors, buyers and realtors. Furthermore, the present invention provides analytical data about the real estate properties to the realtors. Moreover, the investors and buyers are enabled to do their own research and receive notifications with less time as compared to the current standard where the notification is obtained from the realtors. The realtors can share their contractors and resources list. Further, the realtors can easily locate vendors and service providers to the real estate industry like home inspectors, structural engineer and title companies. The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for enabling an investor or a buyer to purchase a real estate property with potential equity, the system comprising:
a memory unit to store:
a database comprising information regarding a plurality of real estate properties posted for sale by a realtor, and
a set of program modules;
a processor to execute the set of program modules, wherein the set of program modules comprise:
an input module, executed by the processor, configured to:
receipt from the investor or the buyer, individual preferences of the investor or the buyer with regards to purchasing a real estate property;
a compatibility module, executed by the processor, configured to calculate compatibility of each of the plurality of real estate properties with the preferences of the investor or buyer;
a real estate property selection module, executed by the processor, configured to select a set of real estate properties from the plurality of real estate properties based upon the preferences of the investor or buyer being compatible with each of the set of real estate properties;
a display module, executed by the processor, configured to present the investor or buyer with the set of real estate properties; and
a purchasing module, executed by the processor, configured to:
receipt from the investor, a request to purchase at least one real estate property among the set of real estate properties, and
receive at least one monetary transaction from the investor or buyer to purchase at least one real estate property, thereby enabling the investor or the buyer to purchase at least one real estate property with the help of their realtor.

2. The system of claim 1, wherein the information regarding the plurality of real estate properties comprises, location of the plurality of real estate properties, proximity of the plurality of real estate properties to schools, commercial districts, hospitals, and government offices in area surrounding the plurality of real estate properties, flood zone maps of areas near the plurality of real estate properties, including property investment, purchase price, potential equity, potential return on investment, individual property characteristics and amenities available in the plurality of real estate properties.

3. The system of claim 1, wherein the preferences of the investor or the buyer comprise location of the real estate property and amenities offered by at least one real estate property.

4. The system of claim 1, wherein the compatibility module is further configured to notify the investor or buyer about the set of real estate properties via at least one of an email, a text message, a voicemail and a phone call.

5. The system of claim 1, wherein the purchasing module is further configured to enable the investor or the buyer to review at least one real estate property and to post comments in a social media forum about at least one real estate property.

6. The system of claim 1, wherein the display module is further configured to:
present advertisements about the plurality of real estate properties, to the investor or buyer, and
request bids from one or more potential investors or buyers.

7. The system of claim 1, wherein the display module is configured to present the investor or buyer with information regarding the plurality of real estate properties via at least one of charts, graphs, tables, and pie charts.

8. A computer implemented method of enabling an investor or buyer to purchase a real estate property, the method comprising:
storing, in a memory unit, information regarding a plurality of real estate properties posted for sale by a realtor;
receiving, at a processor via an input module, preferences of the investor with regards to purchasing at least one real estate property;
calculating, by the processor via a compatibility module, compatibility of each of the plurality of real estate properties with the preferences of the investors or buyer;
selecting, by the processor, via a real estate selection module, a set of real estate properties from the plurality of real estate properties based upon the preferences of the investor or the buyer being compatible with each of the set of real estate properties;
presenting, by the processor via a display module, the set of real estate properties to the investor or the buyer;
receiving, by the processor via a purchasing module, a request from the investor or the buyer, to purchase at least one real estate property among the set of real estate properties; and
receiving, by the processor via the purchasing module, at least one monetary transaction from the investor or the buyer to purchase at least one real estate property, thereby enabling the investor or buyer to purchase at least one real estate property with the help of their realtor.

9. The method of claim 8, wherein the information regarding the plurality of real estate properties comprises, location of the plurality of real estate properties, proximity of the plurality of real estate properties to schools, commercial districts, hospitals, and government offices in area surrounding the plurality of real estate properties, flood zone maps of areas near the plurality of real estate properties, including property investment, purchase price, potential equity, potential return on investment, individual property characteristics and amenities available in the plurality of real estate properties.

10. The method of claim 8, wherein the preferences of the investor or buyer comprise location of at least one real estate property, flood zone maps of areas near at least one real estate property, proximity of at least one real estate property to schools, commercial districts, hospitals, and government offices in area surrounding at least one real estate properties, and amenities offered by at least one real estate property.

11. The method of claim 8, wherein the compatibility module is further configured to notify the investor or buyer about the set of real estate properties via at least one of an email, a text message, a voicemail, and a phone call.

12. The method of claim 8, wherein the purchasing module is further configured to enable the investor or buyer to review at least one real estate property and to post comments in a social media forum about at least one real estate property.

13. The method of claim 8, wherein the display module is further configured to:
present advertisements about the plurality of real estate properties, to the investor or buyer, and
request bids from one or more potential investors or buyers.

14. The method of claim 8, wherein the display module is configured to present the investor or buyers with information regarding the plurality of real estate properties via at least one of charts, graphs, tables, and pie charts.

15. A non-transitory program storage device readable by computer, and comprising a program of instructions executable by a processor to perform a computer implemented method of enabling an investor or buyer to purchase a real estate property, comprising:
storing, in a memory unit, information regarding a plurality of real estate properties posted for sale by a realtor;
receiving, at a processor via an input module, preferences of an investor or buyer with regards to purchasing a real estate property;
calculating, by the processor via a compatibility module, compatibility of each of the plurality of real estate properties with the preferences of the investor or buyer;
selecting, by the processor, via a real estate selection module, a set of real estate properties from the plurality of real estate properties based upon the preferences of the investor or buyer being compatible with each of the set of real estate properties;
presenting, by the processor via a display module, the set of real estate properties to the investor or buyer;
receiving, by the processor via a purchasing module, a request from the investor or buyer, to purchase at least one real estate property among the set of real estate properties; and
receiving, by the processor via the purchasing module, at least one monetary transaction from the investor or buyer to purchase at least one real estate property, thereby enabling the investor or buyer to purchase at least one real estate property with the help of their realtor.
